(19) United States
(12) Patent Application Publication
(10) Pub. No.: US 2026/0225092 A1
(43) Pub. Date: Aug. 6, 2026

(54) Method for the Separation of Zinc and Iron from Electric Arc Furnace Baghouse Dust

(71) Applicant: American Renewable Metals LLC, Bessemer, AL (US)

(72) Inventors: William Rusty Sutterlin, Hoover, AL (US); Mark Tegen, Austin, TX (US)

(73) Assignee: American Renewable Metals LLC, Bessemer, AL (US)

(21) Appl. No.: 19/565,226

(22) Filed: Mar. 12, 2026

Related U.S. Application Data
(63) Continuation-in-part of application No. 18/888,334, filed on Sep. 18, 2024.
(60) Provisional application No. 63/681,508, filed on Aug. 9, 2024.

(51) Int. Cl. B01J 39/05; C22B 3/00; C22B 7/00; C22B 7/02; C22B 19/28

(52) U.S. Cl. CPC B01J 39/05; C22B 7/007; C22B 7/02; C22B 19/22; C22B 19/28

(57) ABSTRACT

Provided are new and improved novel processes and continuous ion exchange/continuous ion chromatography (CIX/CIC) systems for the separation of iron and zinc from electric arc furnace baghouse dust.

### CROSS-REFERENCE TO RELATED APPLICATION

The present application is a continuation-in-part of U.S. application Ser. No. 18/888,334, filed Sep. 18, 2024, which claims priority to U.S. Provisional Application No. 63/681,508, filed Aug. 9, 2024, the entire contents of which are incorporated herein by reference.

### TECHNICAL FIELD

This invention generally relates to industrial metallurgical waste processing and usable material recovery. In alternative embodiments, provided are processes and continuous ion exchange/continuous ion chromatography (CIX/CIC) systems for the separation of zinc, iron and other metals, into individual high purity elements.

### BACKGROUND

Currently the most widely used industrial method to purify the Zinc and Iron from Electric Arc Furnace Baghouse Dust (EAFBD) is the Waelz kiln process. The concept of using a rotary kiln for the recovery of Zinc by volatization dates to at least 1888. A process was patented by Edward Dedolph in 1910. Subsequently, the Dedpolph patent was taken up and developed by Metallgesellschaft (Frankfurt) with Chemische Fabrik Griesheim-Elektron but without leading to a production scale ready process. In 1923 the Krupp

Grusonwerk independently developed a process (1923), named the Waelz process (from the German Waelzen, a reference to the motion of the materials in the kiln); the two German firms later collaborated and improved the process marketing under the name Waelz-Gemeinschaft (German for Waelz association).

The process consists of treating zinc containing material, in which zinc can be in the form zinc oxide, zinc silicate, zinc ferrite, zinc sulphide together with a carbon containing reductant/fuel, within a rotary kiln at 1000° C. to 1500° C. The kiln feed material comprising zinc ‘waste’, fluxes and reductant (coke) is typically pelletized before addition to the kiln. The chemical process involves the reduction of zinc compounds to elemental zinc (boiling point 907° C.) which volatilises, which oxidises in the vapour phase to zinc oxide. The zinc oxide is collected from the kiln outlet exhaust by filters/electrostatic precipitators/settling chambers etc.

Kiln size is typically 50 by 3.6 metres (164 by 12 ft) long/internal diameter, with a rotation speed of around 1 rpm. The recovered dust (Waelz oxide) is enriched in zinc oxide and is a feed product for zinc smelters, the zinc reduced by-product is known as Waelz slag. Sub-optimal features of the process are high energy consumption, and lack of iron recovery (and iron rich slag). The process also captures other low boiling metals in the waelz oxide including lead, cadmium and silver. Halogen compounds are also present in the product oxide.

Increased use of galvanised steel has resulted in increased levels of zinc in steel scrap which in turn leads to higher levels of zinc in electric arc furnace flue dusts. As of 2000, the Waelz process is considered to be a “best available technology” for flue dust zinc recovery and the process is used at industrial scale worldwide. As of 2014, the Waelz process is the preferred or most widely used process for zinc recovery of zinc from electric arc furnace dust (90%).

Alternative production and experimental scale zinc recovery processes include the rotary hearth treatment of pelletised zinc containing dust (Kimitsu works, Nippon Steel); the SDHL (Saage, Dittrich, Hasche, Langbein) process, an efficiency modification of the Waelz process; the “DK process” a modified blast furnace process producing pig iron and zinc (oxide) dust from blast furnace dusts, sludges and other wastes; and the PRIMUS process (multi-stage zinc volatilisation furnace).

Additional processes, such as hydrometallurgical processes in the art include WO1999031285A1, Mortier uses acid digestion to create a leachable suspension and the solution containing iron and zinc is separated from the solids fraction. Mortier lacks the use of a continuous digestion and contacting system to remove first the iron from the solution and then the zinc which limits its ability to be employed commercially.

In BE1001781A6, Josis et al uses a series of chemical digestion and selective precipitation or separation steps in combination with reagents to achieve zinc and iron separation by hydrochloric acid digestion. In U.S. Pat. No. 11,519,053B2, Giordana uses a combination of hydrochloric acid and chlorate and requires a specific and limited iron and zinc content of the input material and does not use ion exchange or continuous ion exchange. In DE112017006996B4, Flock et al uses a hydrochloric acid digestion to separate an iron and carbon containing material into an iron rich material and a carbon rich material whereby ion exchange is used to separate zinc and or lead from the carbon rich fraction. In US20210172042A1, Sutterlin, is a Processes for the separation of rare earth elements and non-rare earth elements into individual high purity elements. Sutterlin claim 3(a) states a process for the separation of rare earth elements (REE) and non-rare earth elements into individual high purity elements, comprising: (a) providing a starting material comprising at least one rare earth element (REE) and at least one non-rare earth elements. Sutterlin US20210172042A1 is focused on using strong acid digestion and continuous chromatography to separate rare earth elements from non rare earth elements and rare earth elements from each other and does not contemplate the non obvious use of acid digestion and continuous ion exchange and molar gradient elution chromatography in combination with carbonic acid for the first production of iron chloride and then second production and direct precipitation of zinc carbonate from electric arc furnace baghouse dust.

The Waelz process is the preferred or most widely used process for zinc recovery of zinc from electric arc furnace dust and is estimated to be used for 90% of the zinc recovered from waste or by product streams. The Waelz process is incredibly energy intensive and creates a non-pure zinc fraction for reuse and is a significant emitter or carbon emission due to its dependence on energy in the kiln step of the process. The hydrometallurgical processes listed are complicated batch processes that are not efficient at scale, inherently wasteful and do not utilize modern continuous process technology. Therefore, it would be useful to have a simple, continuous, flexible, carbon dioxide consuming and efficient method for the recovery of iron and zinc from electric arc furnace baghouse dust that is also a low carbon, energy efficient process.

### SUMMARY

In alternative embodiments, provided are systems, for example, multiplexed systems including pluralities of chromatography columns, for the separation of iron and zinc, into individual high purity forms of metals, oxides or salts, comprising a process as set forth in FIG. 1 and/or FIG. 2 and/or FIG. 3 and/or FIG. 4, and as described herein.

In alternative embodiments, provided are continuous ion exchange/continuous ion chromatography (CIX/CIC) systems for the separation of fraction comprising iron and zinc, into individual high purity fractions, comprising a process as set forth in FIG. 1 and/or FIG. 2 and/or FIG. 3 and/or FIG. 4, and as described herein.

In alternative embodiments, provided are processes for the separation of a form of iron and a form of zinc into individual high purity elements, comprising:
(a) providing a starting material comprising at least a mixture of a form of iron and a form of zinc;
(b) optionally adding an oxidant to the starting material to convert Fe (II) to Fe (III).
(c) mixing the starting material in an acid or acid chloride solution, or adding the starting material to an acid or acid chloride solution, wherein the acid or acid chloride solution has greater than about 0.25 molarity chloride concentration, or between about 0.01 molarity and 10 molarity chloride concentration, preferably 0.6 molarity chloride;
(d) adding or loading the starting material-comprising acid or acid chloride solution of step (c) into or onto an anion exchange resin column, preferably a strong anion resin, whereby any ferric tetrachloride anion (optionally a FeCl₄⁻ complex binds to the anion exchange resin) in the starting material-comprising acid chloride solution is retained on the anion exchange resin, and generating a ferric tetrachloride (FeCl₄⁻ complex) anion-free, cationic metal-comprising eluate; and
(e) adding or loading the starting material-comprising acid or acid chloride solution of step (c) into or onto an anion exchange resin column, preferably a strong anion resin, whereby any Zinc tetrachloride anion (optionally a ZnCl₄²⁻ complex binds to the anion exchange resin) in the starting material-comprising acid chloride solution is retained on the anion exchange resin, and generating a Zinc tetrachloride (ZnCl₄²⁻ complex) anion-free, cationic metal-comprising eluate;
(f) first passing an eluting solution having a low acid concentration of about 0.1 to 1 molarity, preferably 0.25 molarity over the anion exchange resin to elute the ferric chloride;
(g) second passing an eluting solution of water over the anion exchange resin to elute the zinc chloride;
(h) adding or loading the iron and zinc free, cationic metal-comprising eluate of (d) and (e) into or onto a cationic exchange resin column, whereby cations are retained on the cationic exchange resin;
(i) passing low to high gradient acid eluting solutions over or through the cationic exchange resin column, wherein the passing comprises:
(j) first passing an eluting solution having a low acid concentration of about 0.1 to 1 molarity, followed by an eluting solution of about 1 to 2 molarity, followed by an eluting solution of about 3 to 10 or more molarity, or
(k) passing an eluting solution over or through the cationic exchange resin column that changes over time from about 0.1 to 1 molarity, to about 1 to 2 molarity, to about 3 to 10 or more molarity, and
at low acid concentration of about 1 molarity or less, a majority of or greater than 50%, or at least about 50%, 60%, 70%, 80%, 85%, 90% or 95%, of monovalent and/or divalent cations are eluted off the cationic exchange resin column, and at acid concentrations of between about 1 to 2 molarity, a majority of or greater than 50%, or at least about 50%, 60%, 70%, 80%, 85%, 90% or 95%, of trivalent cations (optionally aluminum cations) elute off the cationic exchange resin column, and
at acid concentrations greater than about 3 or more molarity, a majority of or greater than 50%, or at least about 50%, 60%, 70%, 80%, 85%, 90% or 95%, of the tetravalent cations elute off the cationic exchange resin column; and
(k) collecting the eluted monovalent, divalent, trivalent and tetravalent cations as individual fractions.

In alternative embodiments, provided are processes for the separation of a form of iron and a form of zinc into individual high purity elements, comprising:
(a) providing a starting material comprising at least a mixture of a form of iron and a form of zinc;
(b) optionally adding an oxidant to the starting material to convert Fe (II) to Fe (III).
(c) mixing the starting material in an acid or acid chloride solution, or adding the starting material to an acid or acid chloride solution, wherein the acid or acid chloride solution has greater than about 0.25 molarity chloride concentration, or between about 0.01 molarity and 10 molarity chloride concentration, preferably 2-7 molarity chloride;
(d) adding or loading the starting material-comprising acid or acid chloride solution of step (c) into or onto an anion exchange resin column, preferably a strong anion resin, whereby any ferric tetrachloride anion (optionally a FeCl₄⁻ complex binds to the anion exchange resin) in the starting material-comprising acid chloride solution is retained on the anion exchange resin, and generating a ferric tetrachloride (FeCl₄⁻ complex) anion-free, cationic metal-comprising eluate; and
(e) adding or loading the starting material-comprising acid or acid chloride solution of step (c) into or onto an anion exchange resin column, preferably a strong anion resin, whereby any zinc tetrachloride anion (optionally a ZnCl₄²⁹⁻ complex binds to the anion exchange resin) in the starting material-comprising acid chloride solution is retained on the anion exchange resin, and generating a zinc tetrachloride (ZnCl₄²⁹⁻ complex) anion-free, cationic metal-comprising eluate;
(f) first passing an eluting solution having a low acid concentration of about 0.1 to 1 molarity, preferably 0.25 molarity over the anion exchange resin to elute the ferric chloride;
(g) second passing an eluting solution of water and carbon dioxide under pressure forming carbonic acid over the anion exchange resin to elute the solution comprising zinc bicarbonate and or zinc carbonate and or zinc chloride and or free chloride;

The details of one or more exemplary embodiments of the invention are set forth in the accompanying drawings and the description below. Other features, objects, and advantages of the invention will be apparent from the description and drawings, and from the claims.

All publications, patents, patent applications cited herein are hereby expressly incorporated by reference in their entireties for all purposes.

### DESCRIPTION OF DRAWINGS

The drawings set forth herein are illustrative of exemplary embodiments provided herein and are not meant to limit the scope of the invention as encompassed by the claims.

FIG. 1 illustrates an exemplary process for isolating iron chloride and zinc chloride as provided herein.

FIG. 2 illustrates an exemplary process, an exemplary continuous ion exchange/continuous ion chromatography (CIX/CIC) system, for isolating iron chloride and zinc chloride.

FIG. 3 illustrates an exemplary process for isolating iron chloride and zinc carbonate as provided herein.

FIG. 4 illustrates an exemplary process, an exemplary continuous ion exchange/continuous ion chromatography (CIX/CIC) system, for isolating iron carbonate and zinc carbonate.

Like reference symbols in the various drawings indicate like elements.

### DETAILED DESCRIPTION

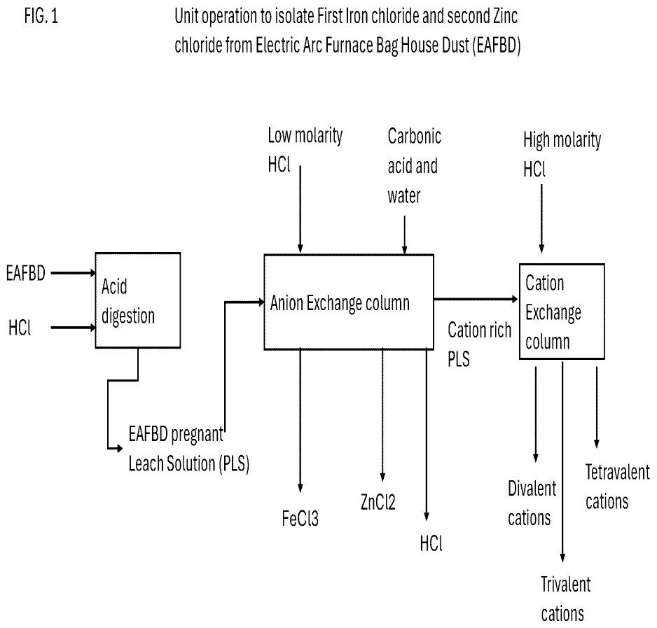

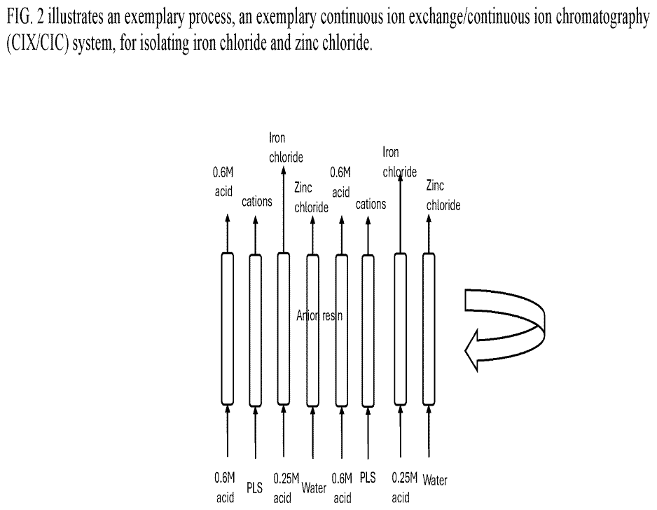

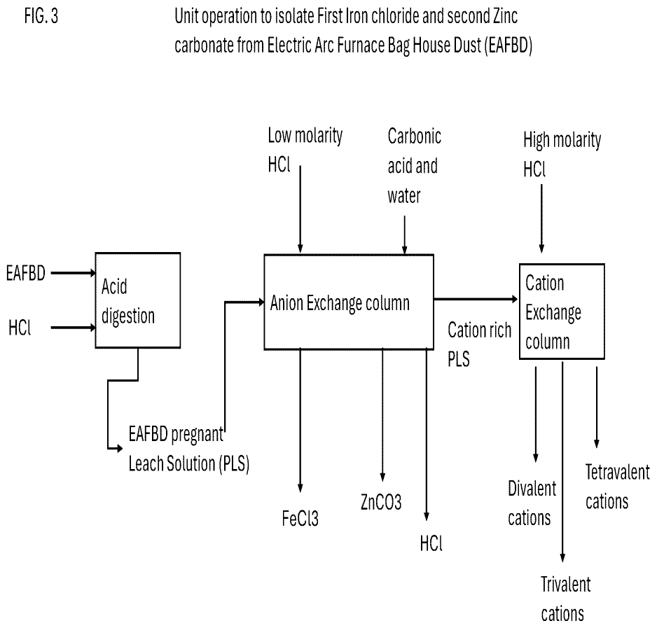

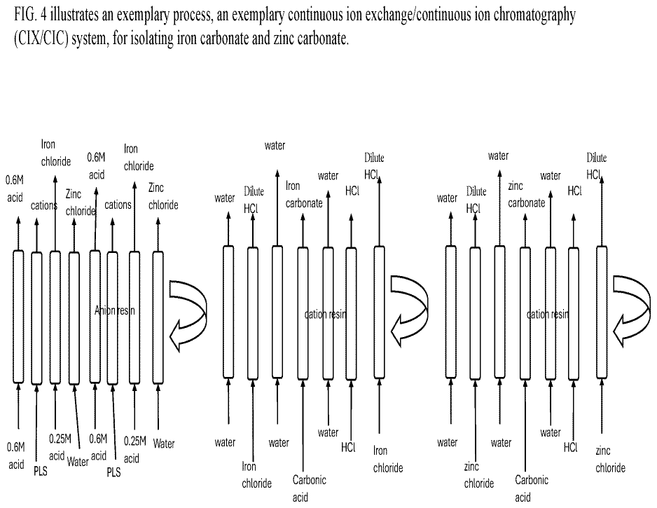

In alternative embodiments, provided are processes for the generation of a substantially pure fraction comprising iron; and a substantially pure fraction comprising zinc from electric arc furnace baghouse dust, comprising a process as set forth in FIG. 1 and/or FIG. 2 and/or FIG. 3 and/or FIG. 4, and as described herein.

Electric arc furnace (EAF) baghouse dust which is a byproduct of the steelmaking process and can contain a variety of metal oxides, salts, and elemental metals. The exact composition can vary depending on the raw materials used and the specific processes employed. However, the forms of iron and zinc typically found in EAF baghouse dust comprise Iron Oxides which are comprising Magnetite (Fe₃O₄), Hematite (Fe₂O₃), Wüstite (FeO) and Iron salts comprising iron chlorides if there is exposure to chlorine or hydrochloric acid, iron chlorides such as FeCl₂, 2FeCl₂, FeCl₃, 3FeCl₃ could form and Elemental Iron or Metallic Iron can be present in small amounts of elemental iron typically in the form of fine particulates.

Forms of Zinc in EAF bag house dust comprise Zinc Oxide (ZnO) which is the most common form of zinc found in EAF dust due to the high temperatures and oxidizing conditions in the furnace and Zinc Ferrite (ZnFe₂O₄, 4ZnFe₂O₄) which is a compound formed when zinc oxide reacts with iron oxides at high temperatures and Zinc Salts comprising Zinc Chlorides (ZnCl₂, 2ZnCl₂) can form if chlorine or hydrochloric acid is present in the environment and Elemental Zinc comprising Metallic Zinc, although less common, metallic zinc can be present in small amounts, typically as fine particulates.

Electric arc furnace (EAF) baghouse dust contains a complex mixture of iron and zinc compounds, primarily in oxide forms. Iron is commonly found as magnetite, hematite, and wüstite, while zinc is usually present as zinc oxide and zinc ferrite. Both metals can also form chlorides if chlorine or hydrochloric acid is involved. Additionally, small amounts of elemental iron and zinc may be present as fine particulates.

EAF baghouse dust typically contains a variety of cations in addition to iron and zinc. These cations come from the raw materials, alloys, and other additives used in the steelmaking process and present in the scrap which is the typical raw material for EAF which generates the EAF bag house dust or electric arc furnace bag house dust (EAFBD). The specific composition can vary, but common cations found in EAF baghouse dust include:

Common Cations in EAF Baghouse Dust comprise Calcium (Ca) Calcium Oxide, often present due to the use of lime (CaO) as a flux in the steelmaking process. Magnesium (Mg), Magnesium Oxide, found in EAF dust as a result of the refractory materials and fluxes. Aluminum (Al) Aluminum Oxide present due to the use of aluminum as a deoxidizer and from alumina refractories. Chromium (Cr), Chromium Oxide found especially in dust from stainless steel production. Nickel (Ni), Nickel Oxide present in dust from stainless steel and special alloy production. Manganese (Mn) Manganese Oxide, common due to manganese's use as an alloying element. Lead (Pb) Lead Oxide can be present, particularly if scrap material with lead is used. Copper (Cu) Copper Oxide found in dust due to the presence of copper in scrap steel. Sodium (Na) and Potassium (K), Sodium Oxide and Potassium Oxide these can be present due to contamination from various sources, including raw materials and additives. Silicon (Si) Silicon Dioxide often found due to the use of silica refractories and as a natural component of raw materials. Trace Cations present in EAF bag house dust comprise Cadmium (Cd) can be present in trace amounts, particularly in galvanized steel scrap. Barium (Ba) is sometimes found in trace amounts. Zirconium (Zr) can be present depending on the specific alloys processed. Niobium (Nb) can be present depending on the specific alloys processed. Niobium Oxide (Nb2O5) present in dust if niobium-containing alloys or stainless steels are processed. Titanium (Ti), Titanium Oxide found in dust when titanium is used as an alloying element or from titanium-containing refractories. Vanadium (V), Vanadium Oxide present in dust from vanadium-containing steels or alloys. Molybdenum (Mo), Molybdenum Oxide found when molybdenum is used as an alloying element, particularly in stainless and high-strength steels. Cobalt (Co), Cobalt Oxide present in dust from cobalt-containing alloys. Tungsten (W), Tungsten Oxide can be present if tungsten alloys or high-speed steels are processed. Tin (Sn), Tin Oxide found in dust from tin-coated steels or tin-containing alloys. Antimony (Sb), Antimony Oxide can be present in trace amounts. Zirconium (Zr), Zirconium Oxide found in dust from zirconium-containing alloys or refractory materials. Cadmium (Cd), Cadmium Oxide present in trace amounts, particularly in galvanized steel scrap. Barium (Ba), Barium Oxide, sometimes found in trace amounts.

In alternative embodiments the acid chloride solution comprises: hydrochloric acid or sulfuric acid combined with a chloride salt, and optionally the chloride salt comprises sodium chloride and water;

In alternative embodiments the optional oxidant solution comprises an oxidizing agent (also known as an oxidant, oxidizer, electron recipient, or electron acceptor) is a substance in a redox chemical reaction that gains or “accepts”/“receives” an electron from a reducing agent (called the reductant, reducer, or electron donor). In other words, an oxidizer is any substance that oxidizes another substance. The oxidation state, which describes the degree of loss of electrons, of the oxidizer decreases while that of the reductant increases; this is expressed by saying that oxidizers “undergo reduction” and “are reduced” while reducers “undergo oxidation” and “are oxidized”. Common oxidizing agents are oxygen, hydrogen peroxide, and the halogens. Common oxidizing agents comprise Oxygen (O₂), Ozone (O₃), Hydrogen peroxide (H₂O₂) and other inorganic peroxides, Fenton's reagent, Fluorine (F₂), chlorine (Cl₂), and other halogens, Nitric acid (HNO₃) and nitrate compounds such as potassium nitrate (KNO₃), the oxidizer in black powder, Potassium chlorate (KClO₃), Peroxydisulfuric acid (H₂S₂O₈), Peroxymonosulfuric acid (H₂SO₅), Hypochlorite, chlorite, chlorate, perchlorate, and other analogous halogen oxyanions, Fluorides of chlorine, bromine, and iodine, Hexavalent chromium compounds such as chromic and dichromic acids and chromium trioxide, pyridinium chlorochromate (PCC), and chromate/dichromate compounds such as Sodium dichromate (Na₂Cr₂O₇), Permanganate compounds such as potassium permanganate (KMnO₄), Sodium perborate, Nitrous oxide (N₂O), Nitrogen dioxide/Dinitrogen tetroxide (NO₂/N₂O₄), Sodium bismuthate (NaBiO₃), Cerium (IV) compounds such as ceric ammonium nitrate and ceric sulfate, and Lead dioxide (PbO₂).

In alternative embodiments the anion exchange resin comprises a polymeric matrix to which functional groups are attached, and optionally the functional groups comprise: tertiary amino groups; primary amines; secondary amines; quaternary ammonium groups or a combination thereof and optionally the polymeric matrix comprises: N₊(CH₃)₃ groups (type 1 resins); —N⁺(CH³)₂C₂H₄OH groups (type 2 resins); or, a combination thereof and optionally the polymeric matrix comprises styrene-divinylbenzene and Base Anion Exchange Resins with Primary Amine: R—NH₂, Secondary Amine: R—NH—R, Tertiary Amine: R—N(R)₂. Some examples of strong anion resins comprise Mitsubishi Chemical: Offers a variety of strongly basic anion exchange resins, including the DIAION™ SA10 Series, DIAION™ PA300 Series, and DIAION™ HPA25L, Purolite Offers SBA resins such as A444, A502P, A860, PFA444, and PPA444, Sunresin: Offers SBA resins such as SEPLITE® LSI106, SEPLITE® LSC719, SEPLITE® LX6703, SEPLITER MA958, SEPLITE® LSC688, and SEPLITE® Monojet™ LSF9720, ResinTech: Offers the SBG1-OH resin, which is suitable for polishing mixed beds. Some examples of anion resins SEPLITE® LX6702: A mixed base anion resin. SEPLITE® MA939: An acrylic, macroporous, free base resin that can remove organic acids LSF930B: A food grade resin designed to remove acids and decolorize sugar, LSF67: A food grade gel type resin with an acrylic matrix, LSF962: A food grade styrene resin with a larger pore size, PFA100Plus/4881: A polystyrenic, macroporous, free base resin with a uniform particle size, PPA100Plus: A polystyrenic, macroporous, free base resin that can remove hexavalent chromium, ResinTech WBMP: A resin that can efficiently remove strong acids like chlorides, sulfates, and nitrates. Some examples of weak anion exchange resins, their functional groups, and the brand names under which they are sold include Polystyrene with Tertiary AmineAmberlite® IRA67, Dowex® 66, Purolite® A100, SEPLITE® LSF9300, Polyacrylic with Tertiary AmineAmberlite® IRA96, Purolite® A847, SEPLITE® MA939, Polystyrene with Primary & Secondary AminesLewatit® MP62Polyacrylic with Mixed AminesSEPLITE® LX6703.

In alternative embodiments the cation exchange resins comprise Strongly acidic cation (SAC) resins. These resins have a sulphonic acid (—SO₃) functional group. The ones in the H-form (—SO₃H) are capable of removing all cations from water or an aqueous stream. For most deionisation applications, SAC resin with an 8% divinylbenzene (DVB) content are used. Generally, they show maximum selectivity for trivalent ions, followed by divalent and monovalent ions. They are regenerated with strong acids, usually HCl or H₂SO₄, and require 200-300% of the theoretical stoichiometric quantity. When used in the hydrogen cycle, the effluent is acidic. The maximum operating temperature of the resin is estimated to 135° C. examples of strong acid cation resin (SAC) comprise Primary Sulfonic Acid: R—SO₃H, Aryl Sulfonic Acid Groups, Benzene Sulfonic Acid C₆H₅SO₃H), Perfluorosulfonic Acid: R—F—SO₃H, Dowex 50, Amberlite IR-120, Amberlyst 15, Nafion, Purolite C100E, Indion 220Na, Seplite Strong Acid Cation Exchange Resin.

In alternative embodiments a weak Acid Cation Exchange Resins is used. Weak acid cation (WAC) exchange resins are a type of ion exchange resin that can exchange cations for hydrogen ions. They typically comprise a carboxylic acid (—COOH) functional group but can contain different functional groups, similar to acetic acid in acidity, and can exchange with bases and weak acid salts. Functional groups comprise Carboxylic Acid (R—COOH), Phosphonic Acid (R—PO₃H₂), WAC resin examples comprise DuPont AmberLite HPR, IRC, and IRA resins, Purolite C104Plus, Mitsubishi Chemical Corporation DIAION series of weakly acidic cation exchange resins, Bio-Rad Macro-Prep CM.

In Alternative embodiments the process is summarized as involving the dissolution of Electric Arc Furnace Baghouse Dust (EAFBD) in HCl, elution of iron and zinc, formation of zinc carbonate, and recovery of chloride ions using reverse osmosis (RO) or nanofiltration (NF) membranes. First the Dissolution of EAF Baghouse Dust in 0.6M hydrochloric acid (HCl). The metals in the dust dissolve, forming their respective chloride complexes. ZnO+2HCl→ZnCl₂+H₂O, Fe₂O₃+6HCl→2FeCl₃+3H₂O. The dissolved solution is then Loaded onto Anion Exchange Resin. The chloride complexes, such as ZnCl₄²⁻ and FeCl₄, bind to the anion exchange resin. Elution of Iron with 0.25M HCl destabilize the FeCl₄⁻ complex and converts to FeCl₃ and elutes from the resin. FeCl₄+H₂O→FeCl₃+Cl⁻+H₂O

Elution of Zinc with Water or Water/Carbonic Acid: Elute the ZnCl₄²⁹⁻ complex using water or a water/carbonic acid mixture. The zinc forms zinc carbonate (ZnCO₃) upon reacting with carbonate ions from carbonic acid. ZnCl₄²⁻+H₂O→ZnCl₂+2Cl⁻+H₂O. ZnCl₄²⁻+H₂O→ZnCl₂+2Cl+H₂O Zn²⁺+CO₃²⁻→ZnCO₃

Recovery of Chloride Ions Using RO or NF Membranes: The remaining solution, containing chloride ions, is processed using reverse osmosis (RO) or nanofiltration (NF) membranes.

Reverse Osmosis (RO): RO membranes remove a wide range of ions and molecules, including chloride ions, by applying pressure to the solution, forcing water through the semi-permeable membrane while retaining the ions.

Nanofiltration (NF): NF membranes selectively remove divalent and larger monovalent ions. Chloride ions can be concentrated and recovered through this process.

Benefits of This Process: Selective Metal Recovery: Efficiently separates and recovers iron and zinc from EAF BD.

High Purity Products: Produces high-purity zinc carbonate and iron chloride.

Chloride Ion Management: Recovers and reuses chloride ions, reducing environmental impact.

Economic and Environmental Efficiency: The process minimizes waste and maximizes the recovery of valuable materials.

In alternative embodiments the EAF bag house dust is dissolved in hydrochloric acid and an oxidant, releasing cations (including Fe² which is converted to Fe³⁺ and Zn²⁺) and forming their corresponding chloride complexes (FeCl₄⁻ and ZnCl₄²⁻). It is then Loaded onto Anion Exchange Resin and the chloride complexes bind to the anion exchange resin. Then the Iron is eluted with 0.25M to 1M HCl whereby reducing the HCl concentration to 0.25M to 1M destabilizes FeCl₄ and converts it to FeCl₃, which then elutes from the resin. The zinc is eluted with Water or Water/Carbonic Acid whereby the ZnCl₄²⁹⁻ complex is less stable in water, leading to its conversion to ZnCl₂ or Zn(OH)₂. If using water saturated with CO₂ (forming carbonic acid), Zn²⁺ can react with CO₂³⁻ to form zinc carbonate (ZnCO₃) and or zinc bicarbonate.

In alternative embodiments the Formation of Zinc Carbonate:

When water is saturated with CO₂ or carbonic acid (H₂CO₃) partially dissociates into bicarbonate (HCO₃—) and carbonate (CO₃²—) ions:

CO₂+H₂O↔H₂CO₃↔H⁺+HCO₃⁻↔2H⁺+CO₃²⁻

The Zn²⁺ ions can react with carbonate ions to form zinc carbonate:

Zn²⁺+CO₃²⁻→ZnCO₃

### Benefits of Forming Zinc Carbonate:

### Easier Handling and Transport:

Zinc carbonate ZnCO₃ is a solid, making it easier to handle, store, and transport compared to solutions of zinc salts.

### High Purity Product:

The precipitation of zinc as zinc carbonate can help achieve a higher purity product, as it may separate more effectively from other impurities still in solution.

### Value-Added Product:

Zinc carbonate has various industrial applications, including use as a precursor for other zinc compounds, in rubber production, ceramics, and as a dietary supplement.

### Environmental Benefits:

Forming a solid product like zinc carbonate can reduce the environmental impact associated with liquid waste disposal.

### Recyclability:

Zinc carbonate can be easily converted back to zinc oxide or other zinc compounds through calcination, making it a versatile intermediate for further processing or recycling.

### Practical Considerations:

pH Control: Ensure that the pH is controlled during the process to favor the formation of ZnCO₃.

The presence of carbonic acid can help maintain a suitable pH.

Concentration of CO₂: Ensure sufficient CO₂ saturation in the water to provide adequate carbonate ions for precipitation.

Separation Efficiency: Verify that the elution conditions effectively separate zinc from other metals that may be present in the dust.

### Fate of Chloride Ions:

The chloride ions (Cl—) initially bound to the anion exchange resin are released into the elution solutions as the metal complexes elute.

After iron and zinc are eluted and separated, the chloride ions are typically found in the remaining aqueous solutions.

These chloride ions can be managed as part of the waste treatment process.

Depending on the setup, they might be neutralized, precipitated, or treated further to avoid environmental contamination.

### Considerations for Chloride Management:

### Neutralization:

Neutralize the solution to precipitate metal hydroxides and potentially release chloride ions in a more manageable form.

In alternative embodiments, add different types of steel slag sources.

In alternative embodiments, processes as provided herein comprise use of one platform technology to extract and purify various feedstocks, where in alternative embodiments only using one platform technology can have the advantages of:
1. The procedure does not require heat or excessive energy.
2. The procedure is able to recycle and recover the majority of the acids.
3. The procedure provides for the efficient recovery of iron as ferric chloride.
4. It does not use large amounts of toxic solvents.
5. The footprint of this technology is significantly smaller than competitive Waelz process systems.
6. The process is continuous.
7. The process does not use exotic equipment
8. The process yields high purity Iron chloride or ferric chloride and zinc carbonate and or zinc chloride and other metals of interest.
9. It consumes carbon dioxide.

In Alternative embodiments the process is summarized as involving the dissolution of Steel Plant Waste comprising Electric Arc Furnace Baghouse Dust (EAFBD) in HCl and forming the chloride complexes comprising ZnCl₄²⁻ and FeCl₄⁻, which bind to the anion exchange resin, and first eluting with 0.25M to 2M HCl and destabilize the FeCl₄⁻ complex and converts to FeCl₃ which elutes from the resin and; second eluting with water to destabilize the ZnCl₄²⁻ to form zinc chloride which elutes from the resin; the two elution solutions can be considered one step or multiple steps or step change gradient elution or elutions. The iron chloride as a substantially pure fraction is collected. The zinc chloride as a substantially pure fraction is collected. The iron chloride fraction is loaded onto a cation exchange resin whereby the iron reversibly sticks to the resin and a hydrogen is exchanged into the solution whereby the chloride present accepts the hydrogen to form dilute HCl. The dilute HCl is removed from the system or resin by passing water over the resin and the iron stays reversibly bound to the cation resin. Once the system is completely free of chloride anions by water washing the system or resin, then carbon dioxide is mixed with the water under pressure ranging from 0.0001 bar to 1,000 bar to form carbonic acid. The presence of carbonic acid of sufficient strength will form iron carbonate with the iron reversibly bound on the resin which liberates the iron carbonate now formed from the resin. The iron carbonate is collected and filtered to form an iron carbonate filter cake. The iron carbonate filter cake is then subjected to heating or calcination whereby the iron carbonate is reduced to iron oxide and carbon dioxide whereby the carbon dioxide is captured and recycled to the process for the formation of carbonic acid and the iron oxide is removed for sale.

Simultaneously on a separate cation exchange resin system or the same system in a separate sequence to the iron chloride loading and conversion to iron carbonate, the zinc chloride fraction is loaded onto a cation exchange resin whereby the zinc reversibly sticks to the resin and a hydrogen is exchanged into the solution whereby the chloride present accepts the hydrogen to form dilute HCl. The dilute HCl is removed from the system or resin by passing water over the resin and the zinc stays reversibly bound to the cation resin. Once the system is completely free of chloride anions by water washing the system or resin, then carbon dioxide is mixed with the water under pressure ranging from 0.0001 bar to 1,000 bar to form carbonic acid. The presence of carbonic acid of sufficient strength will form zinc bicarbonate and or zinc carbonate with the zinc reversibly bound on the resin which liberates the zinc bicarbonate and or zinc carbonate now formed from the resin. The zinc bicarbonate and or zinc carbonate is collected and filtered to form an zinc carbonate filter cake by reducing the pressure of the mixture whereby CO₂ is released and zinc carbonate is formed. The zinc carbonate filter cake is then subjected to heating or calcination whereby the zinc carbonate is reduced to zinc oxide and carbon dioxide whereby the carbon dioxide is captured and recycled to the process for the formation of carbonic acid and the zinc oxide is removed for sale.

The weak hydrochloric acid produced by this cation exchange process is recovered by concentration filtration, evaporative recovery or Nanofiltration (NF) for HCL Recovery Water has a diameter 0.275 nanometers and HCl diameter 0.346 nanometers which makes NF recovery viable. Commercial Membranes have polyamide (PA) selective layer Susceptible to hydrolytic degradation by acids which limit stability with acid feed. Stable Membranes such as Polysulfonamide (PSA) and polyethersulfone (PES), Ceramic Membranes have Low selectivity for small impurities (ionic species/sub-nanometer particles) due to high molecular weight cutoff commercial mebranes include Duracid from GE, MPS-34 from Koch, and HydraCoRe70pHT from Hydranautics are commercial products designed for specific acid stability. A thermally cross-linked branched-polyethyleneimine (b-PEI) layer was introduced to a loose polyethersulfone NF membrane by dip-coating of b-PEI and an epoxy linker and heat treatment in a sealed oven with a high-humidity atmosphere. Some distillation methods for HCl recovery, Extractive Rectification is leading method, Alternatives are dual-pressure technology; or a mixture of the two that may reduce power consumption.

In alternative embodiments the Steel Plant Waste (SPW) processed by this invention can comprise mill scale, sintering dust and sludge from the sintering process; blast furnace dust and sludge from the blast furnace process; steelmaking dust and sludge from steel production in converters; steelmaking dust from steel production in electric arc furnaces; blast furnace and steelmaking slags; ceramic debris; sludges from wet dedusting of burned gases and melting losses. Refining begins at the scrap yard. Electric drive scrap handlers and balance cranes with magnets help to inspect, clean, weigh, sort, and move to bays. Moving cranes pick the metallic load in bays and supply EAF, which transforms scrap and pig iron into molten steel. After the fusion, the liquid steel routes to a ladle furnace (LF) in which, combined with alloys, meet the chemical specifications and the required temperature for casting. The molten steel casts in cooling lines, forming billets and blooms, which are the final products of the melt shop. The EAF and LF operations generate powdery metal emissions, exhausted and deposited by extensive dust collection systems, usually composed of electrostatic precipitators and sleeve filters. The precipitation forms the so-called EAF dust. The conformation starts at the mill rolling shop. The billet reheated at 1000-1200° C. passes through rolling mills, which reduces and modifies the section until reaching the desired profile. The lamination process generates a layer of oxide on the billet, which is the mill scale. There is a second conformation stage, cold drawing, in which a process of cold mechanical conformation occurs. The material undergoes a mechanical stripping process to remove the grease. The wire rod undergoes an annealing process to increase durability and by a zinc bath galvanizing process to protect against oxidation and improve the physical appearance. The galvanizing process generates zinc sludge. The waste of the steelmaking plant comprises slag, EAF dust, mill scale, and zinc sludge.

In alternative embodiments, processes as provided herein subject a starting EAFBD comprising material to an acid leaching producing a pregnant leach solution (PLS). In alternative embodiments, the acid comprises sulfuric acid, nitric acid, hydrochloric acid (HCl acid) or various organic acids or mixtures thereof. In some aspects, HCl acid may be desirable because it produces chloride salts and can be recycled. Using HCl allows for easy removal of the iron. When ferric iron reacts with HCl in the presence of high chlorides it creates the anion complex FeCl₄⁻. This FeCl₄ complex will bind with an anion exchange resin. Greater than 99.8% of the iron can be removed with this technique. Once the FeCl₄⁻ complex is bound to the anion exchange resin it can be released easily by just passing water over it. This water dilutes the FeCl₄⁻ to form FeCl₃ which is not anionic and therefore not attracted to the anion exchange resin. The FeCl₃ solution can be recycled, as it is a popular water flocculating agent used all over the world for water purification.

A similar anionic chloride complex occurs with zinc. Therefore, they will come out of the anion exchange resin at this stage too. This solution can later be further oxidized with air bubbling to ensure that these actinides are in their fully oxidized stated. Thorium has an oxidation state of +4 and uranium will be at +4, +5, +6. The iron is at +3 and Zn at +2. These different oxidations states and the tendency of larger atoms to have higher affinities on IX resins enables the separation of iron and zinc from solution.

### Cation Chromatographic Resin (CIC)

In alternative embodiments after the iron and zinc are removed from the PLS (pregnant leach solution) by anion resin processing and or cation resin processing the remaining PLS rich in cations is subject to processes as provided herein comprise removing the cation exchange resin and replacing it with a chromatographic resin. This allows for tighter separations. In this section the goal is to generate a light, mid, and heavy cut. This section also removes any other monovalent cations that are present.

In alternative embodiments, the cation exchange resin is not removed. In alternative embodiments, processes and systems as provided herein comprise use of multiple columns, e.g., cation exchange resin comprising columns, where each column has its own dedicated resin (which need not ever be removed from that column).

In alternative embodiments the cation rich PLS is subject to Batch Chromatography Column or a Flash Chromatography Column. As an example, at this stage our volume and masses have become too small to run on the continuous system. Therefore, for the next stage, processes as provided herein comprise use of a batch chromatography column or a flash chromatography column. This column was packed with a stationary phase and eluted with a chelating agent in the mobile phase.

The enriched cation fraction can then be separated into fractions of divalent, trivalent and tetravalent cation fractions. Each fraction can then campaigned to isolate individual cations.

In alternative embodiments for processes as provided herein, HCl is the acid of choice. One of the advantages of using HCl is it allows for easy removal of the highest contaminating metal, iron. When iron reacts with HCl in the presence of high chlorides it creates the anion complex FeCl₄⁻. This FeCl₄⁻ complex will bind with an anion exchange resin. As shown in Table 1, below, greater than 99.8% of the iron is removed with this technique. Once the FeCl₄⁻ complex is bound to the anion exchange resin it can be released easily by just passing water over it. This water dilutes the FeCl₄⁻ to form FeCl₃ which is not anionic and therefore not attracted to the anion exchange resin. The FeCl₃ solution is a popular water flocculating agent used all over the world for water purification.

In this embodiment, the PLS solution enters the top of the 1st Iron Removal Column. It exits the bottom of the 1st column and enters the top of the 2nd Iron Removal Column. It exits the bottom of the 2nd column and enters the top of the 3rd Iron Removal Column. The solution that exits the bottom of the 3rd column is collected. After 5 minutes the columns are rotated so that column 3 becomes column 2 and column 2 becomes column 1 and column 1 goes to water washing. This is type of counter current loading. The column 1 has now been fully spent with iron loading and after the 5 minutes rotates to the water wash column that will release all of the absorbed iron.

As discussed above, exemplary CIX systems as provided herein comprise a continuous ion exchange process. In alternative embodiments, the first stage is the separation of the cations by valence. In alternative embodiments, monovalent elements such as sodium and potassium elute off the column with a 1M HCl solution. In alternative embodiments, divalent elements such as calcium and magnesium do not elute until a 2M HCl solution is passed over the columns. In alternative embodiments, the trivalent elements (REEs) are not eluted until a much higher concentrated acid is passed of the columns. Iron is also a trivalent, but, in alternative embodiments, it was removed in a prior anion exchange system.

Unless specifically stated or obvious from context, as used herein, the term “about” is understood as within a range of normal tolerance in the art, for example within 2 standard deviations of the mean. About can be understood as within 10%, 9%, 8%, 7%, 6%, 5%, 4%, 3%, 2%, 1%, 0.5%, 0.1%, 0.05%, or 0.01% of the stated value. Unless otherwise clear from the context, all numerical values provided herein are modified by the term “about.”

Unless specifically stated or obvious from context, as used herein, the terms “substantially all”, “substantially most of”, “substantially all of” or “majority of” encompass at least about 90%, 95%, 97%, 98%, 99% or 99.5%, or more of a referenced amount of a composition.

The entirety of each patent, patent application, publication and document referenced herein hereby is incorporated by reference. Citation of the above patents, patent applications, publications and documents is not an admission that any of the foregoing is pertinent prior art, nor does it constitute any admission as to the contents or date of these publications or documents. Incorporation by reference of these documents, standing alone, should not be construed as an assertion or admission that any portion of the contents of any document is considered to be essential material for satisfying any national or regional statutory disclosure requirement for patent applications. Notwithstanding, the right is reserved for relying upon any of such documents, where appropriate, for providing material deemed essential to the claimed subject matter by an examining authority or court.

Modifications may be made to the foregoing without departing from the basic aspects of the invention. Although the invention has been described in substantial detail with reference to one or more specific embodiments, those of ordinary skill in the art will recognize that changes may be made to the embodiments specifically disclosed in this application, and yet these modifications and improvements are within the scope and spirit of the invention. The invention illustratively described herein suitably may be practiced in the absence of any element(s) not specifically disclosed herein. Thus, for example, in each instance herein any of the terms “comprising”, “consisting essentially of”, and “consisting of” may be replaced with either of the other two terms. Thus, the terms and expressions which have been employed are used as terms of description and not of limitation, equivalents of the features shown and described, or portions thereof, are not excluded, and it is recognized that various modifications are possible within the scope of the invention. Embodiments of the invention are set forth in the following claims.

A number of embodiments of the invention have been described. Nevertheless, it can be understood that various modifications may be made without departing from the spirit and scope of the invention. Accordingly, other embodiments are within the scope of the following claims.

What is claimed is:

1. A process for separating fraction comprising iron and zinc into individual high purity fractions with a continuous ion exchange/continuous ion chromatography (CIX/CIC) system, the process comprising:
(a) providing a starting material comprising at least a mixture of a form of iron and a form of zinc;
(b) optionally adding an oxidant to the starting material to convert Fe (II) to Fe (III);
(c) mixing the starting material in an acid or acid chloride solution, or adding the starting material to an acid or acid chloride solution, wherein the acid or acid chloride solution has greater than about 0.25 molarity chloride concentration, or between about 0.01 molarity and 10 molarity chloride concentration, preferably 8 molarity chloride;
(d) adding or loading the starting material-comprising acid or acid chloride solution of step (c) into or onto an anion exchange resin column whereby any ferric tetrachloride anion (optionally a FeCl₄⁻ complex binds to the anion exchange resin) in the starting material-comprising acid chloride solution is retained on the anion exchange resin, and generating a ferric tetrachloride (FeCl₄⁻ complex) anion-free, cationic metal-comprising eluate;
(e) adding or loading the starting material-comprising acid or acid chloride solution of step (c) into or onto an anion exchange resin column whereby any Zinc tetrachloride anion (optionally a ZnCl₄²⁹⁻ complex binds to the anion exchange resin) in the starting material-comprising acid chloride solution is retained on the anion exchange resin, and generating a Zinc tetrachloride (ZnCl₄²⁹⁻ complex) anion-free, cationic metal-comprising eluate;
(f) first passing an eluting solution having a low acid concentration of about 0.1 to 2 molarity, preferably 0.25 to 1 molarity over the anion exchange resin to elute the ferric chloride; and
(g) second passing an eluting solution of water over the anion exchange resin to elute the zinc chloride.

2. The process according to claim 1, wherein the starting material comprises electric arc furnace baghouse dust (EAFBD).

3. The process according to claim 1, wherein the acid comprises sulfuric acid, nitric acid, hydrochloric acid, an organic acid, or a mixture thereof.

4. The process according to claim 1, wherein the acid chloride solution comprises hydrochloric acid or sulfuric acid combined with a chloride salt, wherein the chloride salt comprises sodium chloride.

5. The process according to claim 1, wherein the acid or acid chloride solution comprises HCl.

6. The process according to claim 1, wherein the optional oxidant is Oxygen (O₂), Ozone (O₃), Hydrogen peroxide (H₂O₂) and other inorganic peroxides, Fenton's reagent, Fluorine (F₂), chlorine (Cl₂), and other halogens, Nitric acid (HNO₃) and nitrate compounds such as potassium nitrate (KNO₃), the oxidizer in black powder, Potassium chlorate (KClO₃), Peroxydisulfuric acid (H₂S₂O₈), Peroxymonosulfuric acid (H₂SO₅), Hypochlorite, chlorite, chlorate, perchlorate, and other analogous halogen oxyanions, Fluorides of chlorine, bromine, and iodine, Hexavalent chromium compounds such as chromic and dichromic acids and chromium trioxide, pyridinium chlorochromate (PCC), and chromate/dichromate compounds such as Sodium dichromate (Na₂Cr₂O₇), Permanganate compounds such as potassium permanganate (KMnO₄), Sodium perborate, Nitrous oxide (N₂O), Nitrogen dioxide/Dinitrogen tetroxide (NO₂/N₂O₄), Sodium bismuthate (NaBiO₃), Cerium (IV) compounds such as ceric ammonium nitrate and ceric sulfate, and Lead dioxide (PbO₂).

7. The process according to claim 1, wherein the anion exchange resin comprises a polymeric matrix to which functional groups are attached, wherein the functional groups comprise tertiary amino groups, primary amines, secondary amines, quaternary ammonium groups, or a combination thereof.

8. The polymeric matrix according to claim 7, wherein the polymeric matrix comprises-N⁺(CH₃)₃ groups (type 1 resins), —N⁺(CH³)₂C₂H₄OH groups (type 2 resins), or a combination thereof and optionally styrene-divinylbenzene and base anion exchange resins with primary amine (R—NH₂), secondary amine (R—NH—R), or tertiary amine (R—N(R)₂).

9. A process for separating fraction comprising iron and zinc into individual high purity fractions with a continuous ion exchange/continuous ion chromatography (CIX/CIC) system, the process comprising:
(a) providing a starting material comprising at least a mixture of a form of iron and a form of zinc;
(b) optionally adding an oxidant to the starting material to convert Fe (II) to Fe (III);
(c) mixing the starting material in an acid or acid chloride solution, or adding the starting material to an acid or acid chloride solution, wherein the acid or acid chloride solution has greater than about 0.25 molarity chloride concentration, or between about 0.01 molarity and 10 molarity chloride concentration, preferably 8 molarity chloride;
(d) adding or loading the starting material-comprising acid or acid chloride solution of step (b) into or onto an anion exchange resin column, whereby any ferric tetrachloride anion (optionally a FeCl₄⁻ complex binds to the anion exchange resin) in the starting material-comprising acid chloride solution is retained on the anion exchange resin, and generating a ferric tetrachloride (FeCl₄⁻ complex) anion-free, cationic metal-comprising eluate; and
(e) adding or loading the starting material-comprising acid or acid chloride solution of step (b) into or onto an anion exchange resin column, whereby any Zinc tetrachloride anion (optionally a ZnCl₄²⁹⁻ complex binds to the anion exchange resin) in the starting material-comprising acid chloride solution is retained on the anion exchange resin, and generating a Zinc tetrachloride (ZnCl₄²⁹⁻ complex) anion-free, cationic metal-comprising eluate;
(f) first passing an eluting solution having a low acid concentration of about 0.1 to 2 molarity, preferably 0.25 to 1 molarity over the anion exchange resin to elute the ferric chloride; and
(g) second passing an eluting solution of water and carbon dioxide under pressure forming carbonic acid over the anion exchange resin to elute the zinc carbonate, zinc chloride, or free chloride.

10. The process according to claim 9, wherein the starting material comprises electric arc furnace baghouse dust (EAFBD).

11. A process for separating fraction comprising iron and zinc into individual high purity fractions with a continuous ion exchange/continuous ion chromatography (CIX/CIC) system, the process comprising:
(a) providing a starting material comprising at least a mixture of a form of iron and a form of zinc;
(b) optionally adding an oxidant to the starting material to convert Fe (II) to Fe (III);
(c) mixing the starting material in an acid or acid chloride solution, or adding the starting material to an acid or acid chloride solution, wherein the acid or acid chloride solution has greater than about 0.25 molarity chloride concentration, or between about 0.01 molarity and 10 molarity chloride concentration, preferably 8 molarity chloride;
(d) adding or loading the starting material-comprising acid or acid chloride solution of step (c) into or onto an anion exchange resin column, whereby any ferric tetrachloride anion (optionally a FeCl₄⁻ complex binds to the anion exchange resin) in the starting material-comprising acid chloride solution is retained on the anion exchange resin, and generating a ferric tetrachloride (FeCl₄⁻ complex) anion-free, cationic metal-comprising eluate; and
(e) adding or loading the starting material-comprising acid or acid chloride solution of step (c) into or onto an anion exchange resin column, whereby any Zinc tetrachloride anion (optionally a ZnCl₄²⁹⁻ complex binds to the anion exchange resin) in the starting material-comprising acid chloride solution is retained on the anion exchange resin, and generating a Zinc tetrachloride (ZnCl₄²⁹⁻ complex) anion-free, cationic metal-comprising eluate;
(f) first passing an eluting solution having a low acid concentration of about 0.1 to 2 molarity, preferably 0.25 to 1 molarity over the anion exchange resin to elute the ferric chloride;
(g) second passing an eluting solution of water over the anion exchange resin to elute the zinc chloride;
(h) loading the essentially pure zinc chloride solution onto a cation exchange resin, and passing water over the resin the remove the chloride solution;
(i) mixing carbon dioxide with the water to form carbonic acid and contacting the carbonic acid solution with the zinc bound cation exchange system forming zinc bicarbonate and or zinc carbonate; and
(j) removing the zinc carbonate by precipitation or filtration from the eluate.

12. The process according to claim 11, wherein the starting material comprises electric arc furnace baghouse dust (EAFBD).

13. The process according to claim 11, wherein the acid comprises sulfuric acid, nitric acid, hydrochloric acid, an organic acid, or a mixture thereof.

14. The process according to claim 11, wherein the acid chloride solution comprises hydrochloric acid or sulfuric acid combined with a chloride salt, wherein the chloride salt comprises sodium chloride.

15. The process according to claim 11, wherein the optional oxidant is Oxygen (O₂), Ozone (O₃), Hydrogen peroxide (H₂O₂) and other inorganic peroxides, Fenton's reagent, Fluorine (F₂), chlorine (Cl₂), and other halogens, Nitric acid (HNO₃) and nitrate compounds such as potassium nitrate (KNO₃), the oxidizer in black powder, Potassium chlorate (KClO₃), Peroxydisulfuric acid (H₂S₂O₈), Peroxymonosulfuric acid (H₂SO₅), Hypochlorite, chlorite, chlorate, perchlorate, and other analogous halogen oxyanions, Fluorides of chlorine, bromine, and iodine, Hexavalent chromium compounds such as chromic and dichromic acids and chromium trioxide, pyridinium chlorochromate (PCC), and chromate/dichromate compounds such as Sodium dichromate (Na₂Cr₂O₇), Permanganate compounds such as potassium permanganate (KMnO₄), Sodium perborate, Nitrous oxide (N₂O), Nitrogen dioxide/Dinitrogen tetroxide (NO₂/N₂O₄), Sodium bismuthate (NaBiO₃), Cerium (IV) compounds such as ceric ammonium nitrate and ceric sulfate, and Lead dioxide (PbO₂).

16. The process according to claim 11, wherein the anion exchange resin comprises a polymeric matrix to which functional groups are attached, wherein the functional groups comprise tertiary amino groups, primary amines, secondary amines, quaternary ammonium groups, or a combination thereof.

17. The polymeric matrix according to claim 16, wherein the polymeric matrix comprises-N⁺(CH₃)₃ groups (type 1 resins), —N⁺(CH³)²C²H₄OH groups (type 2 resins), or a combination thereof and optionally styrene-divinylbenzene and base anion exchange resins with primary amine (R—NH₂), secondary amine (R—NH—R), or tertiary amine (R—N(R)₂).

18. The process according to claim 11, wherein the cation exchange resins comprise Strongly acidic cation (SAC) resins.

19. The cation exchange resins according to claim 18, the cation exchange resins have a sulphonic acid (—SO₃) functional group.

20. The process according to claim 11, wherein the weak cation exchange resin comprises a carboxylic acid group (—COOH) or a Phosphonic Acid group (—PO₃H₂).
